(19) United States
(12) Patent Application Publication
(10) Pub. No.: US 2020/0304628 A1
(43) Pub. Date: Sep. 24, 2020

(54) PORTABLE ELECTRONIC DEVICE MANAGEMENT

(71) Applicant: Xylon LLC, Las Vegas, NV (US)

(72) Inventor: Thomas W. LYNCH, Austin, TX (US)

(73) Assignee: Xylon LLC, Las Vegas, NV (US)

(21) Appl. No.: 16/897,148

(22) Filed: Jun. 9, 2020

Related U.S. Application Data
(63) Continuation of application No. 11/752,483, filed on May 23, 2007.

(51) Int. Cl. H04M 1/725

(52) U.S. Cl. CPC H04M 1/72563

(57) ABSTRACT

Embodiments of methods, devices and/or systems for managing portable electronic devices are described.

### CROSS-REFERENCE TO RELATED APPLICATIONS

This application is a continuation of application Ser. No. 11/752,483 filed on May 23, 2007, the entire disclosure of which is herein incorporated by reference.

### FIELD

This disclosure is related to management of portable electronic devices such as wireless phones, personal data assistants (PDA), .mp3 players, handheld computers, laptop computers and the like.

### BACKGROUND

Over the last few decades as portable electronic devices have proliferated, these devices have become more integrated with a user's lifestyle. For a variety of reasons, portable electronic devices typically will periodically interact with a user. For example, portable electronic devices may interact with a user responsive to an event. As one example, a PDA typically provides an audible notification for a scheduling event, in order to invite a user to interact with the PDA. A user may interact with the PDA to acknowledge and/or silence the audible notification. Additionally, a wireless phone may receive a call and may provide an audible notification that a call is being received, to invite the user to interact with the phone. As some additional examples, portable electronic devices may employ batteries that may be occasionally recharged, may utilize software that may be occasionally upgraded, and/or may require data uploading, data downloading, rebooting, firmware upgrades, and the like, and a portable electronic device may invite a user to interact with the device in response to these events. When a portable electronic device invites a user to interact with the device, the device may provide a notification, such as an audible, visual or physical notification.

### BRIEF DESCRIPTION OF THE DRAWINGS

Subject matter is particularly pointed out and distinctly claimed. Claimed subject matter, however, both as to organization and method of operation, together with objects, features, and advantages thereof, may best be understood by reference of the following detailed description when read with the accompanying drawings in which:

FIG. 1 is block diagram of an example embodiment of a portable electronic device.

FIG. 2 is a flow diagram illustrating an embodiment of a process of managing a portable electronic device.

FIG. 3 is a flow diagram illustrating an embodiment of a process of managing a portable electronic device.

FIG. 4 is a flow diagram illustrating an embodiment of a process of managing a portable electronic device.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “processing,” “computing,” “selecting,” “sending,” “receiving,” “transmitting,” “determining”, “obtaining”, “interacting”, “storing”, “alerting” and/or the like refer to the actions and/or processes that may be performed by a portable electronic device, which manipulates and/or transforms data represented as physical, electronic and/or magnetic quantities and/or other physical quantities within the computing platform's processors, memories, registers, and/or other information storage, transmission, reception and/or display devices. Accordingly, a portable electronic device refers to a system or a device that includes the ability to process and/or store data in the form of signals. Thus, embodiments of a portable electronic device may comprise hardware, software, firmware and/or any combination thereof. Further, unless specifically stated otherwise, a process as described herein, with reference to flow diagrams or otherwise, may also be executed and/or controlled, in whole or in part, by a portable electronic device.

As mentioned previously, portable electronic devices may periodically invite a user to interact with the device. In this context, inviting a user to interact with the device may be referred to as “user interaction” and may refer generally to the portable electronic device interacting with a user by providing a notification, such as an audible, visual or physical notification. However, as will be explained in more detail hereinafter, inviting a user to interact with a device may be performed for a variety of reasons and in a variety of manners, and claimed subject matter is not so limited. Furthermore, a user may interact with the portable electronic device in response to the invitation. In this context, a user interacting with a device may be referred to as “device interaction”. Accordingly, in this context “device interaction” refers generally to use of the portable electronic device by the user. The portable electronic device may be used by the user responsive to an event. For example, as will be explained in more detail later, a user may use a device responsive to an event such as a need for a battery recharge, a received message, a received phone call, a need for device rebooting, a need for data downloading, a need for updating device software, a need for saving and/or deleting data, and the like. In accordance with these examples, device interaction may comprise charging a battery, message acknowledgement, answering a phone call, rebooting a device, downloading data, updating device software, saving and/or deleting data, and the like. A user may interact with the portable electronic device by employing a user interface, such as a keypad, touch screen, mouse and/or additional interface methods and devices, but claimed subject matter is not so limited.

As one example of inviting a user to interact with a device, a portable electronic device may utilize batteries that can be periodically recharged. The portable electronic device may detect an event, such as a need for a battery recharge. The device may notify the user that a recharge is needed in response to the detected event. The notification may comprise an audible notification such as an alarm, as just an example. Accordingly, the user may perform device interaction in response to the notification by silencing the audible alarm and/or placing the device in a cradle and/or plugging the device into a power supply, as just a few examples. However, an invitation to interact with a device may not always occur at a time or in a manner convenient for a user. For example, batteries of a portable electronic device may run low on charge in the middle of the night, and the device may provide an audible notification in the middle of the night, which may be undesirable to the user. As an additional example, a user may attend a meeting and may forget to mute a wireless phone before the meeting. The wireless phone may receive a call and in response, may provide an audible notification to the user while the user is in the meeting, which may also be inconvenient. Accordingly, it may be desirable, for a variety of reasons, to synchronize a user notification with a user's characteristics, such as a user's behavior or habits, so that a device may invite user interaction at a time or in a manner that is convenient for the user. In at least one embodiment, this may comprise determining one or more characteristics of a user, and synchronizing a notification with a user's characteristics, such that the device may invite user interaction at a time or in a manner convenient for the user. In this manner, management of a portable electronic device may comprise synchronously managing a device such that a notification is synchronized with characteristics of the user, in order to improve user convenience and/or reliability and/or availability of the device. In one context, this may result in forming a symbiotic relationship between a device and a user.

User characteristics may comprise data obtained from numerous sources that may at least partially identify a user's behavior or habits, for example. In one embodiment, user characteristics may comprise a user's daily schedule, a user's location, when a user is awake and asleep, when a user typically uses a particular device, when a user is busy or not busy, how long the user uses the device, and the like. As will be explained in more detail later, user characteristics may be obtained in a variety of ways. User characteristics may be employed such that a device invites a user to interact with the device at a time or in a manner convenient for the user. For example, a user may only be able to charge a device that employs rechargeable batteries at particular times, such as when at home, when in the office or while driving. It may be desirable for a portable electronic device to invite user interaction during these particular times, regardless of whether a battery charge is needed at that specific time, for example. As an additional example, a device may periodically detect an event, such as a need for data to be downloaded, such as for an operating system update. The device may employ user characteristics to determine when a user may be able to download the data, or when a user may be in a location conducive to downloading the data, such as at home or in the office. As yet an additional example, a device may periodically detect an event, such as a received text message. The device may employ user characteristics to determine when a user may be awake or asleep, or busy or not busy, and may provide a user notification in a manner consistent with this determination. For example, user characteristics may be employed to determine that a user is asleep. Accordingly, in this example, a visual notification instead of an audible notification may be provided to a user that the text message was received. User characteristics may be employed to invite a user to download data via a notification at a time convenient for the user. However, these are merely examples, and numerous other types and categories of synchronizing a notification with characteristics of the user are within the scope of claimed subject matter.

As some additional examples, a device may utilize rechargeable batteries, and the device may detect an event in the form of an indication that the batteries may need to be charged in 12 hours. However, user characteristics may be employed by a device to determine that a user will be unavailable to charge the batteries in 12 hours. In response to this determination, a device may invite a user to interact with the device before the end of the 12 hours when there is a need to recharge, such that the device will not run out of battery charge at a time inconvenient for the user. Furthermore, a device such as a wireless phone may detect an event in the form of a received call. The wireless phone may employ user characteristics to determine that a user is in a meeting and will be unable to answer the call. In response to the determination, the wireless phone may not provide a notification in response to the call, but may provide a notification after the meeting, which would be more convenient for the user. As set forth the in examples described above, in at least one embodiment, management of portable electronic devices may comprise synchronizing a user's behavior with the need for device interaction of the portable electronic device. However, as mentioned previously, it is worthwhile to note that claimed subject matter is not limited in this respect.

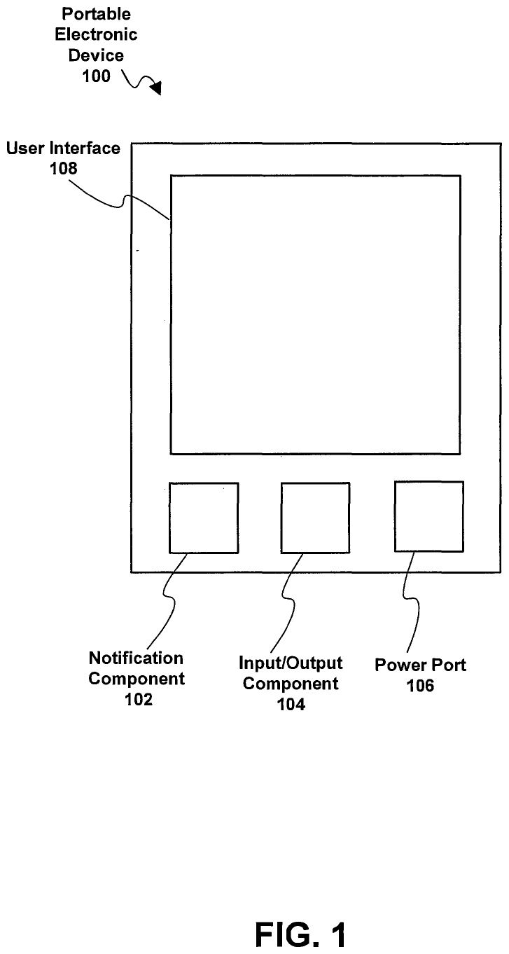

FIG. 1 is a block diagram of one embodiment of a portable electronic device 100. However, it is worthwhile to note that portable electronic devices in accordance with one or more embodiments may include a variety of types and categories of devices, and are not limited to the illustrated embodiments. For example, portable electronic devices include wireless phones, personal data assistants (PDA), .mp3 players, handheld computers, laptop computers and the like. However, other types and categories of portable electronic devices not listed in detail may be employed in alternative embodiments. As noted previously, portable electronic device 100 may periodically detect an event. Additionally, portable electronic device 100 may perform user interaction, such as to invite a user to perform device interaction responsive to the event. In this embodiment, portable electronic device 100 includes a notification component 102 that may perform notification functions. A notification component comprises a component adapted to initiate or invite user interaction with device 100, such as an audible, visual or physical notification. Notification component 102 may comprise, for example, a light-emitting diode (LED), a speaker, a buzzer, and the like, although in alternative embodiments a notification component may be integrated into one or more other portions of portable electronic device, such as a Liquid Crystal Display (LCD) screen, as will be explained herein. Portable electronic device 100 further comprises an input/output (I/O) component 104. I/O component 104 may be adapted to enable sending and/or receiving of data, and may comprise, for example, a data port such as a Universal Serial Bus (USB) port, an Ethernet-compliant port, an infrared port, Bluetooth enabled circuitry and the like. Furthermore, I/O component 104 may comprise a keyboard, a touchpad, a wireless antenna and associated circuitry, and the like. However, it is worthwhile to note that these are merely components of a portable electronic device according to particular embodiments, and claimed subject matter is not so limited.

Continuing with this particular embodiment, portable electronic device 100 further comprises a power port 106. Power port 106 is adapted to receive a connection to a power source, and may enable charging of batteries of the portable electronic device, for example. Additionally, in alternative embodiments, a power port may not be employed as part of portable electronic device 100. For example, a device may not employ rechargeable batteries, and may operate via other power sources such as disposable batteries, a wired power source such as an external power outlet, solar power, and the like. Portable electronic device 100 further comprises a user interface 108. User interface 108 may comprise numerous types of components such as an LCD screen, one or more LEDs, a phone receiver and microphone, and/or the like. In an alternative embodiment, user interface 108 is adapted to perform user interaction functions to notify a user for requesting, initiating and/or inviting user interaction, in addition to or instead of a notification component 102, for example. Although not illustrated, portable electronic device 100 may additionally include processors, memories, registers, and/or other information storage, transmission, reception and/or display components, although, again, claimed subject matter is not so limited.

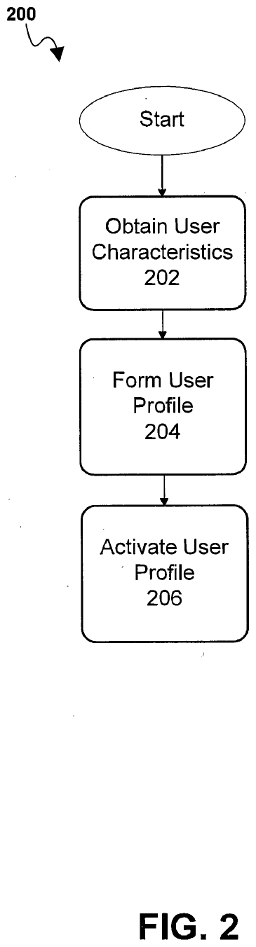

In operation, portable electronic device 100 may periodically detect an event, and may invite interaction by a user responsive to the event, as explained previously. In one particular embodiment, portable electronic device 100 comprises a wireless telephone. The batteries of the wireless telephone may periodically need to be recharged. In this embodiment, depending, for example, on the extent of use, a charge may be required every day or every few days. It may be difficult to predict when such a charge may be required, or whether the wireless telephone will have a charge when it is needed. Accordingly, in one embodiment of claimed subject matter, the need for recharging batteries may be coordinated with one or more characteristics of a user. In one embodiment, in response to the detected event that a charge will be needed, a user profile of a user of the wireless phone may be obtained, and may be employed to indicate and/or identify characteristics of a user. The user profile may include one or more user characteristics. The wireless phone may interact with the user responsive to the detected event and in accordance with user characteristics obtained from the user profile. In this manner, management of a portable electronic device may comprise synchronizing an invitation for a user to interact with the device with characteristics of the user, in order to improve user convenience and/or reliability and/or availability of the device. However, additional embodiments will be explained in more detail with reference to FIGS. 2-4. Furthermore, as alluded to previously, interaction by a user is not limited to the above examples. Additional types of user interaction may comprise rebooting a portable electronic device, performing software and/or hardware upgrades or maintenance, uploading and/or downloading data, replacing components, turning functionality on or off, acknowledging alarms and the like.

FIG. 2 is a flow diagram of a process 200 according to an example embodiment for management of a portable electronic device. However, for flowcharts presented herein, the order in which the particular operations are presented does not necessarily imply a particular order of operation, and may comprise fewer operations or additional intervening, substitute, or subsequent operations. At block 202, user characteristics may be obtained. User characteristics may comprise numerous types and categories of data that may at least partially identify a user's behavior or habits, for example. In one embodiment, user characteristics may comprise a daily schedule, a user's location, when a user is awake and asleep, when a user typically uses a particular device, how long the user uses the device, and the like. User characteristics may be obtained in a variety of ways. For example, user characteristics may be obtained by having the user complete a survey that may comprise software executing on the portable electronic device, for example. Additionally, user characteristics may be obtained by monitoring a user's use of a portable electronic device over a particular time period and/or may be obtained by accessing an electronic calendar that may be at least partially embodied on the portable electronic device. However, it is worthwhile to note that claimed subject matter is not limited in this respect, and may include numerous methods for obtaining user characteristics that may not be described in detail.

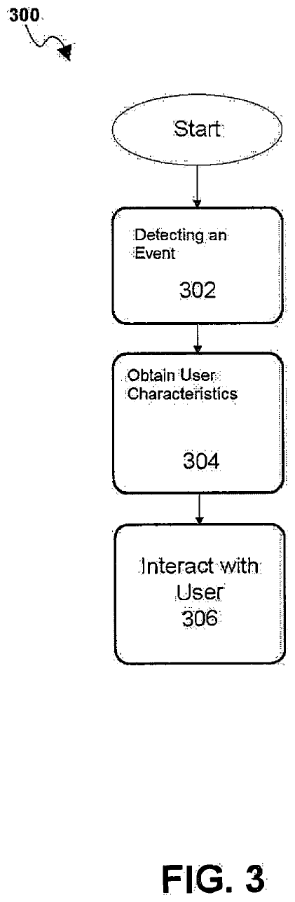

At block 204, user characteristics gathered at block 202 may be employed to form a user profile. As mentioned previously, user characteristics may comprise a user's schedule, times when a user may use a particular portable electronic device, when a user may have resources such as a power source available or unavailable, and the like. A user profile may be formed in order to coordinate an invitation to a user to perform device interaction with user characteristics, to make using a device more convenient for a user, for example. The user profile may include any type of data that may enable managing a portable electronic device in accordance with one or more embodiments, and may be embodied on hardware, software, firmware, and/or the like. At block 206, the user profile may be activated. Activation may occur in response to any one of several events such as when a user powers on or logs on to a portable electronic device and/or may be performed at designated times and/or upon the occurrence of events, such as an indication that user interaction may be required for a portable electronic device. Additionally, a portable electronic device may have a plurality of users, and, accordingly, may be enabled to activate a user profile correlating with a current user of the device. The activated user profile may be employed in one or more embodiments as set forth in FIG. 3. However, in other embodiments, activation of a user profile may not be required, and a user profile may be always active, for example. In this embodiment, functions of block 206 may not be employed, for example.

FIG. 3 is a flow diagram of a process 300 according to an example embodiment for management of a portable electronic device. In one embodiment, at block 302, an event may be detected in a portable electronic device. For example, a portable electronic device may receive a phone call or a message, may determine that a battery charge is desired, and/or may determine that maintenance such as data uploading/downloading or rebooting may be desired, as just a few examples. Responsive to the detected event, at block 304, user characteristics may be obtained. User characteristics may comprise numerous types of data, as described previously. User characteristics may be obtained from a user profile generated in accordance with flowchart 200 of FIG. 2, for example, and may comprise all or a portion of a user profile. At block 306, the portable electronic device may interact with a user responsive to the obtained user characteristics. For example, the portable electronic device may employ a notification component and/or a user interface to invite a user to interact with the device. In addition to notifying a user, in an alternative embodiment, the device may provide instructions to the user for the interaction, such as via a user interface device such as an LCD screen, for example.

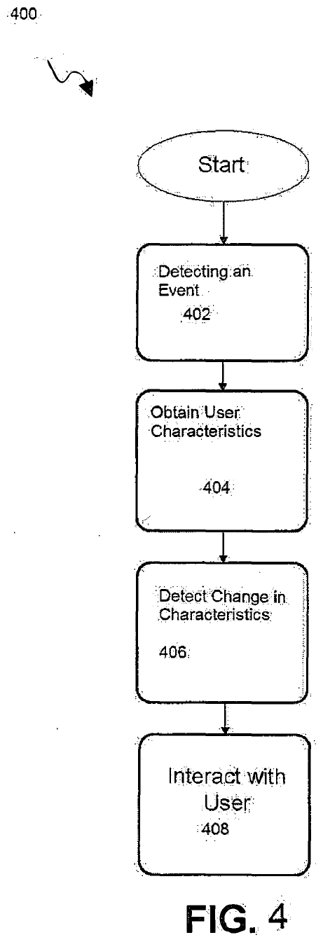

FIG. 4 is a flow diagram of a process 400 according to another example embodiment for management of a portable electronic device. In this example embodiment, at block 402, an event may be detected in a portable electronic device. For example, a portable electronic device may receive a phone call or a message, may determine that a battery charge is desired, and/or may determine that maintenance such as data uploading/downloading or rebooting may be desired. Responsive to the detected event, at block 404 user characteristics may be obtained. User characteristics may comprise numerous types of data, as described previously. User characteristics may be obtained from a user profile generated in accordance with flowchart 200 of FIG. 2, for example, and may comprise all or a portion of a user profile. At block 406, a change in user characteristics may be detected. For example, user characteristics may comprise a user's schedule. At block 406, a change in a user's schedule may be detected in one or more ways, such as by detecting that a user is using the device at a time when user characteristics indicate that the user will not be using the device, detecting that a user is at a location that user characteristics indicate that the user will be, and/or by detecting that a battery charge is low when user characteristics indicate that a user should have recently charged the device. However, other changes to user characteristics may be detected in a variety of ways, and the claimed subject matter is not so limited. At block 408, the portable electronic device may interact with a user responsive to the obtained user characteristics. For example, the portable electronic device may employ a notification component and/or a user interface to invite a user to interact with the device. In addition to notifying a user, in an alternative embodiment, the device may provide instructions to the user for the interaction, such as via a user interface device such as an LCD screen, for example.

The following discussion details several possible embodiments for accomplishing embodiments of management of a portable electronic device. However, these are merely examples and are not intended to limit the scope of claimed subject matter. As another example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a an electronic device, such as a portable electronic device may result in an embodiment of a method in accordance with claimed subject matter being executed, such as one of the embodiments previously described, for example. As one potential example, an electronic device may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example. It will, of course, be understood that, although particular embodiments have just been described, claimed subject matter is not limited in scope to a particular embodiment or implementation.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that appended claims are intended to cover all such modifications and/or changes as fall within the true spirit of claimed subject matter.

What is claimed is:

1. A system including a memory storing instructions operable to, when executed by at least one processor, perform operations including:
detecting an event in a portable electronic device associated with a person;
obtaining at least one user characteristic from a user profile responsive to said detected event;
detecting a change in the at least one user characteristic; and
providing a notification to invite user interaction in a manner synchronized with the detected change in the at least one user characteristic, wherein the notification is provided responsive to the detected event.

2. The system of claim 1, wherein the operations further include:
determining that the detected change in the at least one user characteristic corresponds to an activity from a predetermined set of activities;
wherein providing the notification to invite the user interaction in the synchronized manner comprises providing the notification based on a result of the determining.

3. The system of claim 2, wherein the predetermined set of activities includes one or more activities conducive to downloading data.

4. The system of claim 2, wherein the set of activities includes a user-specified activity and one or more additional activities that are different than the user-specified activity.

5. The system of claim 4, wherein the one or more additional user-specified activities include an event selected from a group comprising the user being at home, the user being in the office, or the user driving.

6. The system of claim 1, wherein the event comprises a manually-triggered event or an automatically-triggered event.

7. The system of claim 6, wherein the manually-triggered event comprises a received call.

8. The system of claim 1, wherein the providing the notification to invite user interaction in the synchronized manner includes:
providing a type of notification selected from a plurality of different types of notifications based on the detected change in the at least one user characteristic; or
providing the notification at a time selected from a plurality of different times based on the detected change in the at least one user characteristic.

9. The system of claim 8, wherein the operations further include:
providing one of an audible notification and a visual notification to invite the user interaction in the case that detected change in the at least one user characteristic coincides with at least one predefined criterion; and
providing the other of the audible notification and the visual notification to invite the user interaction in the case that the detected change in the at least one user characteristic does not coincide with the at least one predefined criterion.

10. The system of claim 8, wherein the operations further include:
providing the notification during a time period in the case that the detected change in the at least one user characteristic coincides with at least one predefined criterion; and
providing the notification outside the time period in the case that the detected at least one user characteristic does not coincide with the at least one predefined criterion.

11. The system of claim 1, wherein the portable electronic device comprises a wearable portable electronic device.

12. The system of claim 1, further comprising:
an input/output (I/O) component coupled to the one or more processors, wherein the notification to invite interaction comprises a notification to invite interaction via the I/O component.

13. The system of claim 12, wherein the I/O component comprises a user interface of the portable electronic device or a machine interface of the portable electronic device.

14. The system of claim 13, further comprising:
wherein the machine interface comprises a short range radio, wherein the notification to invite interaction comprises a notification to invite interaction via a user interface coupled to the short range radio.

15. The system of claim 14, wherein the short range radio comprises Bluetooth enabled circuitry.

16. The system of claim 13, wherein the machine interface comprises a data port of the portable electronic device.

17. The system of claim 13, wherein the user interface of the portable electronic device comprises a touch interface on the portable electronic device.

18. The system of claim 12, wherein the notification is provided using the I/O component or wherein the notification is provided using at least one additional component of the portable electronic device, wherein the at least one additional component comprises a notification component.

19. The system of claim 18, wherein the notification is provided using the I/O component or the notification component depending on the detected change in the at least one user characteristic.

20. The system of claim 1, wherein the at least one user characteristic is obtained by accessing an electronic calendar.

21. A method, comprising:
detecting an event in a portable electronic device associated with a person;
obtaining at least one user characteristic from a user profile responsive to said detected event;
detecting a change in the at least one user characteristic; and
providing a notification to invite user interaction in a manner synchronized with the change in the at least one user characteristic, wherein the notification is provided responsive to the detected event.

22. The method of claim 21, further comprising:
determining that the detected change in the at least one user characteristic corresponds to an activity from a predetermined set of activities;
wherein providing the notification to invite the user interaction in the synchronized manner comprises providing the notification based on a result of the determining.

23. The method of claim 22, wherein the providing the notification to invite user interaction in the synchronized manner includes:
providing a type of notification selected from a plurality of different types of notifications based on the detected change in the at least one user characteristic; or
providing the notification at a time selected from a plurality of different times based on the detected change in the at least one user characteristic.

24. The method of claim 23, further comprising:
providing one of an audible notification and a visual notification to invite the user interaction in the case that the detected change in the at least one user characteristic coincides with at least one predefined criterion; and
providing the other of the audible notification and the visual notification to invite the user interaction in the case that the detected change in the at least one user characteristic does not coincide with the at least one predefined criterion.

25. The method of claim 23, further comprising:
providing the notification during a time period in the case that the detected change in the at least one user characteristic coincides with at least one predefined criterion; and
providing the notification outside the time period in the case that the detected change in the at least one user characteristic does not coincide with the at least one predefined criterion.
